(19) United States
(12) Patent Application Publication
(10) Pub. No.: US 2026/0237384 A1
(43) Pub. Date: Aug. 13, 2026

(54) SPEECH RECOGNITION METHOD, ELECTRONIC DEVICE AND STORAGE MEDIUM

(71) Applicants: Beijing Zitiao Network Technology Co., Ltd., Beijing (CN); BYTEDANCE TECHNOLOGY LTD., Grand Cayman (KY)

(72) Inventors: Bihong ZHANG, Beijing (CN); Jun ZHANG, Beijing (CN); Lu LU, Los Angeles, CA (US)

(21) Appl. No.: 19/535,592

(22) Filed: Feb. 10, 2026

(30) Foreign Application Priority Data
Feb. 10, 2025 (CN) 202510147252.5

(51) Int. Cl. G10L 15/183; G10L 15/02; G10L 15/06; G10L 21/0216; G10L 21/0208

(52) U.S. Cl. CPC G10L 15/183; G10L 15/02; G10L 15/063; G10L 21/0216; G10L 2021/02087

(57) ABSTRACT

Embodiments of the present disclosure provide a speech recognition method, an electronic device and a storage medium. The method includes: determining a speech feature vector of a first speech; obtaining an associated speech and an associated text that are associated with the first speech, and determining feature vectors of the associated speech and the associated text respectively, to obtain an associated speech feature vector and an associated text feature vector; and recognizing the speech feature vector based on the associated speech feature vector and the associated text feature vector, to obtain a recognition text of the first speech.

### CROSS-REFERENCE TO RELATED APPLICATION

This application claims the priority of Chinese Patent Application No. 202510147252.5 filed on February 10, 2025, the disclosure of which is incorporated by reference herein in its entirety as part of the present application.

### TECHNICAL FIELD

Embodiments of the present disclosure relate to the field of computer and speech recognition technologies, and in particular, to a speech recognition method, an electronic device, and a storage medium.

### BACKGROUND

Because speech input is easier to operate and higher in input efficiency than text input, users increasingly use speech for information input in human-computer interaction.

When a user uses speech input for human-computer interaction, automatic speech recognition (ASR) needs to be performed on input speech information, to convert the speech information into text. The correctness of a speech recognition result seriously affects the quality of human-computer interaction. To improve the quality of human-computer interaction through speech, speech recognition accuracy needs to be improved.

### SUMMARY

Embodiments of the present disclosure provide a speech recognition method and a device, to improve speech recognition accuracy.

According to a first aspect, an embodiment of the present disclosure provides a speech information processing method, including:

determining a speech feature vector of a first speech (for example, a to-be-recognized speech);

obtaining an associated speech and an associated text that are associated with the first speech, and determining a feature vector of the associated speech and a feature vector of the associated text, respectively, to obtain an associated speech feature vector and an associated text feature vector; and

recognizing the speech feature vector based on the associated speech feature vector and the associated text feature vector, to obtain a recognition text of the first speech.

According to a second aspect, an embodiment of the present disclosure provides a speech recognition device, including:

a determination unit, configured to determine a speech feature vector of a first speech;

a determination unit, configured to obtain an associated speech and an associated text that are associated with the first speech, and determine a feature vector of the associated speech and a feature vector of the associated text, respectively, to obtain an associated speech feature vector and an associated text feature vector; and

a recognition unit, configured to recognize the speech feature vector based on the associated speech feature vector and the associated text feature vector, to obtain a recognition text of the first speech.

According to a third aspect, an embodiment of the present disclosure provides an electronic device, including: a processor and a memory;

the memory stores a computer-executed instruction; and

the processor executes the computer-executed instruction stored in the memory, to cause the processor to execute the speech recognition method according to the first aspect above and various possible designs of the first aspect.

According to a fourth aspect, an embodiment of the present disclosure provides a computer-readable storage medium, where a computer-executed instruction is stored in the computer-readable storage medium, and when the computer-executed instruction is executed by a processor, the speech recognition method according to the first aspect above and various possible designs of the first aspect is implemented.

According to a fifth aspect, an embodiment of the present disclosure provides a computer program product, including a computer program, and when the computer program is executed by a processor, the speech recognition method according to the first aspect above and various possible designs of the first aspect is implemented.

### BRIEF DESCRIPTION OF DRAWINGS

To describe the technical solutions in the embodiments of the present disclosure or in the prior art more clearly, the following briefly introduces drawings required for describing the embodiments or the prior art. Apparently, the drawings in the following description show some embodiments of the present disclosure, and other drawings may also be obtained by a person of ordinary skill in the art according to these drawings without creative efforts.

FIG. 1 is a first schematic flowchart of a speech recognition method according to an embodiment of the present disclosure;

FIG. 2 is a second schematic flowchart of a speech recognition method according to an embodiment of the present disclosure;

FIG. 3 is a schematic flowchart of model training according to an embodiment of the present disclosure;

FIG. 4 is a block diagram of a structure of a speech recognition device according to an embodiment of the present disclosure; and

FIG. 5 is a schematic diagram of a hardware structure of an electronic device according to an embodiment of the present disclosure.

### DETAILED DESCRIPTION

To make objectives, technical solutions and advantages of embodiments of the present disclosure clearer, the technical solutions in the embodiments of the present disclosure will be described clearly and comprehensively with reference to the drawings in the embodiments of the present disclosure. Apparently, the described embodiments are some embodiments of the present disclosure, rather than all the embodiments. All other embodiments obtained by a person of ordinary skill in the art based on the embodiments of the present disclosure without creative efforts shall fall within the protection scope of the present disclosure.

A user may perform human-computer interaction through speech. For example, the user performs information exchange with an intelligent assistant (such as a chat robot) through speech, to obtain related information through the intelligent assistant or instruct the intelligent assistant to complete a task. When the user performs human-computer interaction through speech, a speech recognition system needs to recognize speech information input by the user (convert the speech information into a corresponding text), and speech recognition accuracy will seriously affect a human-computer interaction result.

To improve the speech recognition accuracy, in some related technologies, in the speech recognition system, keywords in a conversation message may be extracted, and the keywords are used as hot word incentives to improve a recognition effect when a hot word list is hit by a user speech request in a next round. Specifically, in a preliminary speech recognition process, an ASR system tries to recognize keywords in a speech. These keywords are usually important words related to the context, such as names of people, names of places, and technical terms. Once these keywords are recognized, the ASR system marks them as "hot words" to improve the priority and weight of these keywords in a subsequent recognition process. The ASR system dynamically adjusts its acoustic model and language model, and may be more inclined to recognize these hot words in the subsequent recognition process. However, in this manner, if the hot word list is inaccurate or contains wrong keywords, the ASR system may mistakenly give priority to recognizing these words, resulting in an increase in the probability of misrecognition, which is not conducive to improving the speech recognition accuracy. In addition, this method requires additional resources to maintain the hot word list, causing waste of resources.

The embodiments provide the speech recognition method and the device. In the method, when the first speech (for example, a to-be-recognized speech) is recognized, the speech feature vector of the first

speech is recognized based on the associated speech feature vector and the associated text feature vector, to obtain the recognition text of the first speech, and thus speech recognition accuracy can be improved.

In the present disclosure, when a first speech is recognized, a speech feature vector of the first speech is recognized according to an associated speech and an associated text. The associated speech and the associated text may be used as a message background for recognizing the first speech. According to the message background and the first speech, an implicit meaning, a topic transition and the like in an information exchange process may be captured, and therefore recognition errors can be reduced, and the accuracy of a recognition text can be improved. In addition, in the solution, there is no need to maintain a hot word list, and waste of resources can be reduced.

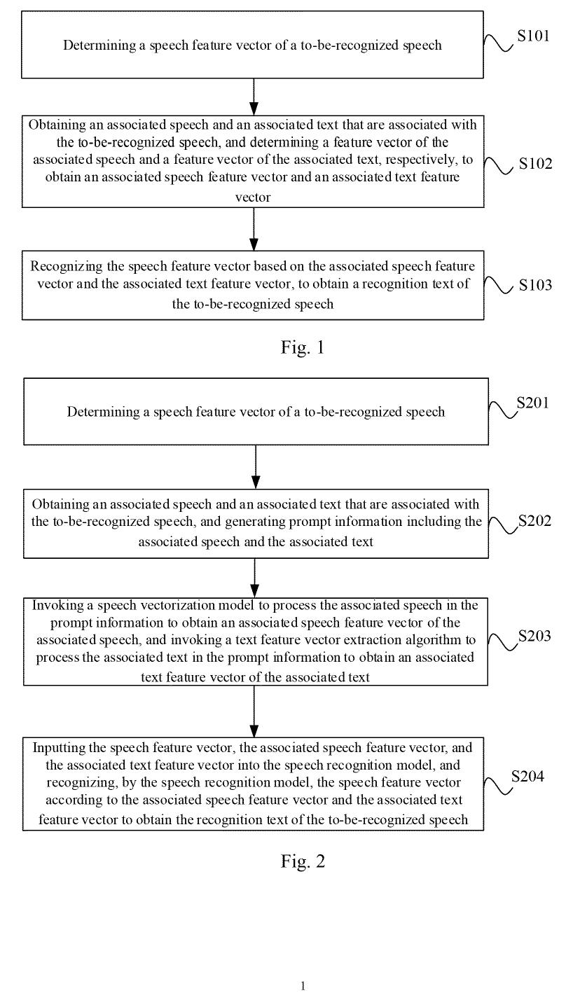

Please refer to FIG. 1. FIG. 1 is a first schematic flowchart of a speech recognition method according to the present disclosure. As shown in FIG. 1, the method includes the following steps.

S101: determining a speech feature vector of a first speech.

An execution body of the speech recognition method may be a terminal device, specifically, may be a preset application client running in the terminal device; or a server, specifically, may be a preset application server running in the server to provide a service for the application client running in the terminal device.

The preset application may receive a speech input by a user, and use the speech as the first speech.

In an example, feature extraction may be performed on the first speech to obtain a first speech feature, and then the first speech feature is vectorized to obtain the speech feature vector of the first speech.

The feature extraction performed on the first speech may include steps such as preprocessing, framing, windowing, Fourier transform, power spectrum calculation, Mel filter bank, discrete cosine transform (DCT), difference coefficient calculation, and mean normalization performed on the first speech, to obtain the first speech feature. The first speech feature may include key attribute features of the captured speech, such as tone, timbre, and pronunciation mode, which may be used for tasks such as speech recognition and speaker recognition.

In an example, an audio encoder may be called to encode the first speech to obtain the speech feature vector of the first speech. The process of encoding the first speech by using the audio encoder may extract key features from the original audio data, and these key features may be used for tasks such as speech recognition and speaker recognition. In addition, the original audio data is usually high-dimensional time-sequence data, and processing such data requires high computing costs. By encoding the audio data by using the audio encoder, the data may be compressed into a low-dimensional space while retaining useful information, and computing resources can be reduced.

S102: obtaining an associated speech and an associated text that are associated with the first speech, and determining a feature vector of the associated speech and a feature vector of the associated text, respectively, to obtain an associated speech feature vector and an associated text feature vector.

In some examples, a context of the associated speech and the associated text is related to a context of the first speech. The context (also referred to as a situation or a scene) refers to a language environment, and may be the context in a coherent speech event.

In an example, the context of the associated speech and the associated text and the context of the first speech may be the same context, and the associated speech and the associated text are context content of the first speech in the context. For example, in a scenario where a user performs information exchange with an intelligent assistant, the first speech may be speech currently input by the user, the associated speech may be speech historically input by the user, and the associated text may be text replied by the intelligent assistant for the speech historically input by the user.

In some application scenarios, there may be more than one piece of associated speech, and there may be more than one piece of associated text.

For each associated speech, speech feature extraction may be performed separately to obtain an associated speech feature corresponding to the associated speech. When feature extraction is performed on each associated speech, a feature extraction method same as that for the first speech may be used.

For each associated text, text feature extraction may be performed to obtain an associated text feature corresponding to the associated text.

S103: recognizing the speech feature vector based on the associated speech feature vector and the associated text feature vector, to obtain a recognition text of the first speech.

This step may also be referred to as a decoding process, in which the speech feature vector may be recognized as one or more characters, and the one or more characters form the text recognized from the first speech.

In some implementations, a recognition model may be built using a deep learning method, and the recognition model directly receives the original audio and text as input, and outputs the final recognition text. In some implementations, the speech feature vector may be input to a classifier (such as a support vector machine or a random forest classifier) for text prediction.

In this embodiment, the associated speech feature vector and the associated text feature vector are introduced to assist in recognizing the first speech feature vector. In the process of performing text recognition on the first speech, the contents of the associated speech and the associated text are referred to, so that user intention may be better predicted and understood. The message background is built using the associated speech and the associated text to capture the implicit meaning, topic transition and the like in the information exchange process, so that recognition errors can be reduced. Due to consistency of a language used by the user in the same context, a personalized expression of the user is recognized according to the associated speech, and the first speech is recognized based on the recognized personalized expression of the user, which is favorable for improving speech recognition accuracy. In addition, in the solution, there is no need to additionally maintain a hot word list, and waste of resources can be avoided.

In some other related technologies, an ASR system includes a language processing model as a base model, and may generate prompt information including dialog history message text and user first speech information, and input the prompt information and the user first speech information into the language processing model, and the language processing model recognizes the user first speech according to a text context. The technical solution in which the first speech is recognized by the language processing model according to the text context has certain accuracy in a dialog recognition scenario, but still has low accuracy in a complex dialog recognition scenario. For example, when there is an error in ASR text in dialog history, using the ASR text with the error may cause error propagation. When the user's speech has an accent or dialect, different dialects may have similar pronunciation when saying different contents. For example, "2" in Cantonese is similar in pronunciation to "1" in Mandarin. The language processing model cannot distinguish dialects only by means of text dialog history. In summary, when the text dialog history cannot provide sufficient audio environment-related information, recognition accuracy of the speech processing model for the first speech is often reduced. The solution provided in the embodiment shown in FIG. 2 can solve the above problem.

Please refer to FIG. 2. FIG. 2 is a second schematic flowchart of a speech recognition method according to the present disclosure. As shown in FIG. 2, the method includes the following steps.

S201: determining a speech feature vector of a first speech.

In this embodiment, an execution body of the speech recognition method may be a preset application running in a terminal device. For the specific implementation of step S201, reference may be made to the description of step S101 in the embodiment shown in FIG. 1, and details are not described herein again.

S202: obtaining an associated speech and an associated text that are associated with the first speech, and generating prompt information including the associated speech and the associated text.

In an example, the associated speech and the associated text may be context of the first speech. For example, the first speech may be a piece of speech in a conversation, and the associated speech may be speech input by a user in a preset dialog turn before the first speech in the conversation; and the associated text may be text input by the user in the preset dialog turn before the first speech in the conversation, or text replied by a peer end (for example, including an intelligent assistant or another user having a conversation with the user) for a message (a text message or a speech message) input by the user.

It should be understood that, in the solution of the present disclosure, the first speech, the associated speech, and the associated text are all obtained with user authorization.

In this embodiment, a speech recognition model built by using a pre-trained natural language processing model as a base may be used for speech recognition.

To enable the speech recognition model to accurately recognize the speech feature vector of the first speech, the prompt information may be generated first. The associated speech and the associated text

may be written into the prompt information here, to obtain the prompt information in which the associated speech and the associated text are mixed.

In some implementations, the first speech, the associated speech, and the associated text may be written into the prompt information at the same time. The associated speech and the associated text may be written into a reference content field, the first speech may be written into a to-be-recognized content field, and the prompt information may further include related prompt information for prompting the speech recognition model to perform speech recognition on the first speech according to the associated speech and the associated text.

S203: invoking a speech vectorization model to process the associated speech in the prompt information to obtain an associated speech feature vector of the associated speech, and invoking a text feature vector extraction algorithm to process the associated text in the prompt information to obtain an associated text feature vector of the associated text.

The speech vectorization model here may be a model that performs vectorization on an audio signal. In an example, the speech vectorization model may be an audio encoder.

In some application scenarios, the first speech, and the associated speech and the associated text of the first speech may be obtained, the first speech is processed using the speech vectorization model to obtain the speech feature vector of the first speech, and the associated speech is processed using the speech vectorization model to obtain the associated speech feature vector.

The text feature vector extraction algorithm may be various algorithms that extract features from texts and vectorize the text features, such as a bag-of-words model algorithm, a term frequency-inverse document frequency algorithm, a word embedding model algorithm, and the like.

S204: inputting the speech feature vector, the associated speech feature vector, and the associated text feature vector into the speech recognition model, and recognizing, by the speech recognition model, the speech feature vector according to the associated speech feature vector and the associated text feature vector to obtain the recognition text of the first speech.

In an example, the associated speech feature vector, the associated text feature vector, and the speech feature vector may be concatenated, and a concatenated vector obtained through concatenating is input into the speech recognition model. It can be understood that the speech recognition model may recognize the associated speech feature vector, the associated text feature vector, and the speech feature vector of the first speech in the concatenated vector.

The speech feature vector is usually represented in a form of a numerical matrix, and each column or each row represents a feature vector of a time frame. Each element in the feature vector is a value of a certain feature in the frame. The features include but are not limited to: Mel-frequency cepstral coefficients (MFCC), linear prediction coefficients (LPC) representing a spectral envelope of a speech signal, linear prediction cepstral coefficients (LPCC) sensing linear prediction (PLP), fundamental frequency (F0), energy and short-time energy, and dynamic features obtained through first-order difference and second-

order difference calculation performed on features such as MFCC and LPC. These features may be used to map the speech signal to text.

The speech recognition model may be obtained by performing fine-tuning on the pre-trained natural language processing model, and the speech recognition model can convert an input speech signal into a text sequence.

After the speech feature vector of the first speech is input into the speech recognition model, the text corresponding to the speech feature vector, that is, the recognition text of the first speech, may be generated by the speech recognition model.

When the recognition text corresponding to the speech feature vector is recognized, text recognition is performed on the first speech in combination with the contextual information reflected by the associated text feature vector and the associated speech feature vector, so that personalized recognition may be performed on the user's speech. For example, if the user uses a specific language (such as a dialect) to perform information exchange, the associated speech and the first speech usually use the same language, and therefore the user's personalized feature can be learned from the associated speech feature vector, and the personalized feature is used to recognize the speech feature vector of the first speech, which is favorable for improving speech recognition accuracy. The accent or dialect used by the user may be recognized through the associated speech, and when the same pronunciation corresponds to different words in different dialects or accents, the accent or dialect recognized from the associated speech is used to recognize the first speech, so that the speech recognition accuracy can be further improved.

In this embodiment, the prompt information including the associated speech and the associated text is generated, the associated speech and the associated text in the prompt information are vectorized to obtain the associated speech feature vector and the associated text feature vector, and the speech recognition model recognizes the speech feature vector of the first speech in combination with the associated speech feature vector and the associated text feature vector. Therefore, when the first speech is recognized by the speech recognition model, the speech recognition model can learn the contextual information provided by the associated text and the associated speech, and use the contextual information to eliminate ambiguity, to accurately understand polysemy and homophones in the current speech. The associated speech and the associated text may be used to recognize and correct recognition errors, and the accuracy of the recognition text obtained by recognizing the first speech can be improved.

In some implementations of this embodiment, there is at least one piece of associated speech, and there is at least one piece of associated text; and the step S202 of generating the prompt information including the associated speech and the associated text includes:

writing each piece of associated speech and each piece of associated text into a preset prompt information template in sequence according to a generation time sequence, to obtain the prompt information.

As an example, in a conversation scenario, each piece of associated speech may be a complete message historically sent by the user to another conversation participant in a form of speech. Each piece of

associated text may be a complete message historically sent by the user to another conversation participant in a form of text, or may be a message sent by another conversation participant to the user in the form of text. Illustratively, the text message sent by another user may be a reply message that replies to the message sent by the user.

As an example, in a video conference scenario, the first speech may be speech information input by a current speaker in a current period of time; and the associated speech may include historical speech information of the speaker in the video conference, and may also include a historical speech of another speaker.

Each piece of associated speech may correspond to one time stamp.

In this example, a presentation document may be used in the video conference, and the associated text may be part of text content of the presentation document, for example, part of text content in the presentation document that is displayed to a user in a time period covered by the time stamp corresponding to each piece of associated speech.

Each piece of associated speech and each piece of associated text may be written into the prompt information according to a sequence of generation time, and therefore the prompt information may retain the sequence of different pieces of associated speech and different pieces of associated text, and can reflect a logical relationship between the different pieces of associated speech and different pieces of associated text.

In some implementations of this embodiment, the step S204 includes the following steps.

First, concatenating the associated speech feature vector corresponding to each piece of associated speech and the associated text feature vector corresponding to each piece of associated text in the order in the prompt information, and input a concatenated vector obtained through concatenating into the speech recognition model.

Second, recognizing the speech feature vector by the speech recognition model according to each associated speech feature vector and each associated text feature vector parsed from the concatenated vector, to obtain the recognition text.

In these implementations, because each associated speech feature vector and each associated text feature vector are concatenated according to the sequence of each piece of associated speech and each piece of associated text in the prompt information, the speech recognition model can recognize each associated speech feature vector and each associated text feature vector from the concatenated vector, and learn the speaker's timbre, speech speed, accent and pronunciation features from the concatenated vector, and can also learn rich contextual information, which facilitates recognition of polysemous words, homophones and sentence structures. Historical speech recognition errors can be recognized, and speech recognition model parameters or mapping relationships can be adjusted according to the historical speech recognition errors to reduce future recognition errors. The first speech is recognized according to a speech recognition manner

of a recognized historical user using language (such as a dialect), which is favorable for improving speech recognition accuracy.

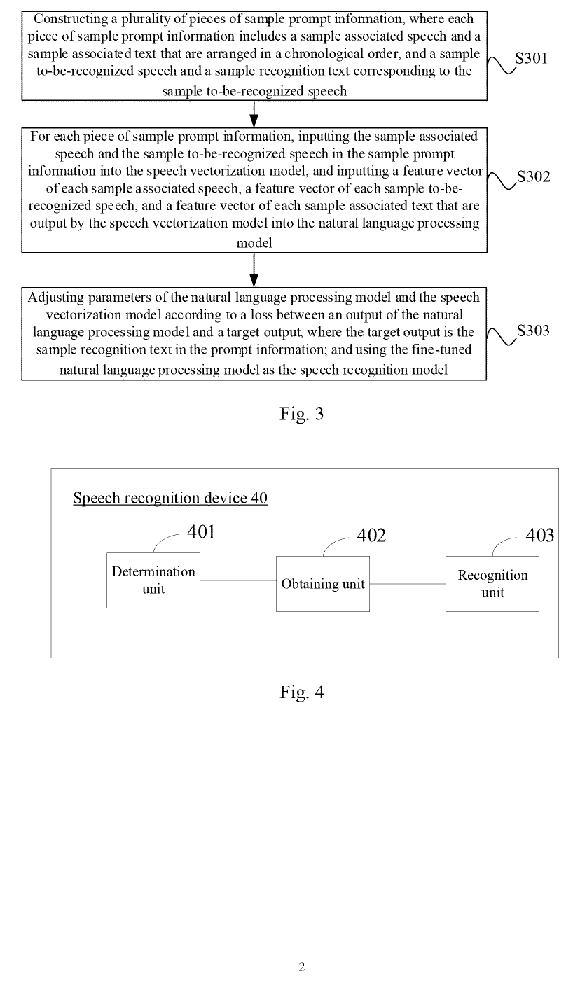

In some embodiments, please refer to FIG. 3. FIG. 3 is a schematic flowchart of model training according to an embodiment of the present disclosure. As shown in FIG. 3, the method further includes performing a plurality of rounds of fine-tuning on a pre-trained natural language processing model and a speech vectorization model based on the following steps, to obtain a speech recognition model and the speech vectorization model.

S301: constructing a plurality of pieces of sample prompt information, where each piece of sample prompt information includes a sample associated speech and a sample associated text that are arranged in a chronological order, and a sample first speech and a sample recognition text corresponding to the sample first speech.

In some application scenarios, the sample associated speech and the sample associated text, the sample first speech, and the sample recognition text corresponding to the sample first speech in each piece of sample prompt information may be content generated in an actual scenario.

As an example, in a scenario where a user performs information exchange with an intelligent assistant through speech, a speech message input by the user may be selected as the sample first speech; speech in one or more rounds of conversation before the sample first speech may be used as the sample associated speech, and text input by the user or replied by the intelligent assistant to the user in the one or more rounds of conversation is used as the sample associated text; and the sample first speech may be labeled with a real text, and the labeled real text is used as the sample recognition text.

The sample prompt information may include a plurality of fields, such as an associated information field, a first speech field, and an output field. Each piece of sample associated speech and each sample associated text may be written into the associated message field according to a sequence of generation time, the sample first speech is written into the first speech field, and the sample recognition text is written into the output field as a target output.

As an example, the sample associated speech, the sample associated text, the sample first speech, the sample recognition text and the like may also be manually prepared, and the prompt information including the above content may be generated.

As an example, the sample prompt information may further include sample associated speech with historical recognition errors, a sample associated text, a sample first speech, and an accurate sample recognition text of the sample first speech. Through the sample prompt information, the speech recognition model can learn the ability to correct subsequent speech recognition even if the historical speech recognition has errors.

S302: for each piece of sample prompt information, inputting the sample associated speech and the sample first speech in the sample prompt information into the speech vectorization model, and inputting a feature vector of each sample associated speech, a feature vector of each sample first speech, and a feature

vector of each sample associated text that are output by the speech vectorization model into the natural language processing model.

S303: adjusting parameters of the natural language processing model and the speech vectorization model according to a loss between an output of the natural language processing model and a target output, where the target output is the sample recognition text in the prompt information; and using the fine-tuned natural language processing model as the speech recognition model.

In this embodiment, the parameters of the pre-trained natural language processing model and the speech vectorization model may be jointly fine-tuned.

A preset loss function may be used to calculate the loss between the output of the speech recognition model and the target output, and the loss function may include, for example, a cross-entropy loss function, a connectionist temporal classification (CTC) loss function, a negative log-likelihood (NLL) loss function, and a mean squared error (MSE) loss function.

The parameters of the natural language processing model and the speech vectorization model are adjusted according to the loss, so as to reduce the loss between the target output and the output obtained by the speech vectorization model and the natural language processing model after the parameter adjustment according to the input.

After a plurality of rounds of training, the training may be stopped after a preset condition is met, to obtain the fine-tuned natural language processing model and the fine-tuned speech vectorization model, and the fine-tuned natural language processing model is used as the speech recognition model.

In the fine-tuning process, the natural language processing model can learn to recognize the first speech according to the alternating audio and text association information in the prompt information as the context content of the first speech; can learn how to map the speech signal to a corresponding text representation; learn to adapt to different accents and languages; and learn noise recognition, etc. Through the fine-tuning process, the natural language processing model can perform speech recognition efficiently and accurately in a speech recognition task.

In some implementations, the associated speech and the first speech carry noise, and the step S204 includes the following steps.

First, a noise feature is recognized from the associated speech feature vector using the speech recognition model, and a noise feature in the speech feature vector is recognized according to the recognized noise feature.

Second, the recognized noise feature is filtered by the speech recognition model, and the speech feature vector from which the noise feature is filtered is recognized to obtain the recognition text.

In these embodiments, the first speech and the associated speech may be obtained by collecting an audio signal by an audio collecting apparatus, and it is inevitable to collect noise in the process of collecting the audio signal by using the audio collecting apparatus. The noise here may refer to various types of audio signals other than the speech of the main speaker.

In these implementations, the speech recognition model may recognize the noise feature from one or more pieces of associated speech feature vectors. Noise reduction may be performed on the speech feature vector of the first speech according to the noise feature.

For example, the associated speech may include long-duration speech, while the current first speech has a short duration, and it is difficult to recognize noise from the short-duration speech. Therefore, if the current first speech carries short-time noise, the noise cannot be recognized, and thus the first speech cannot be accurately recognized. The speech recognition model may recognize the noise feature from the long-duration associated speech, and then filter out the noise feature recognized from the associated speech feature vector in the speech feature vector of the first speech, and recognize the speech feature vector from which the noise feature is filtered out, thereby realizing noise recognition according to the context of the first speech and filtering out the noise, which facilitates improvement of speech recognition accuracy.

In some implementations, the noise includes a speech of another user other than a main speaker.

In these implementations, other audio signals other than the speech of the main speaker may be used as noise, and in this way, the noise may include the speech of other users collected by the audio collecting apparatus.

In some application scenarios, when the main speaker performs speech input, there are other users talking around the main speaker, and the speech content of the other users has nothing to do with the theme described by the main speaker, and may be regarded as interference information. If the speech of other users is also recognized during speech recognition, text content unrelated to the theme of the main speaker will be inserted into the recognition text, which makes the coherence of the speech recognition result poor and affects the accuracy of the speech recognition result.

In these implementations, the speech of users other than the main speaker is also processed as noise, and during speech recognition, the speech of other users may be filtered out, and the speech of the main speaker from which the speech of other users is filtered out is recognized, so that the interference of the speech of other users can be excluded, which is favorable for improving the coherence of the recognized text, and further improving the accuracy of the speech recognition result.

Corresponding to the speech recognition method in the foregoing embodiments, FIG. 4 is a structural block diagram of a speech recognition device according to an embodiment of the present disclosure. For ease of description, only parts related to the embodiments of the present disclosure are shown. Referring to FIG. 4, the device includes: a determination unit 401, an obtaining unit 402, and a recognition unit 403.

The determination unit 401 is configured to determine a speech feature vector of a first speech.

The obtaining unit 402 is configured to obtain an associated speech and an associated text that are associated with the first speech, and determine a feature vector of the associated speech and a feature vector of the associated text, respectively, to obtain an associated speech feature vector and an associated text feature vector.

The recognition unit 403 is configured to recognize the speech feature vector based on the associated speech feature vector and the associated text feature vector, to obtain a recognition text of the first speech.

In an embodiment of the present disclosure, the obtaining unit 402 is further configured to:

obtain the associated speech and the associated text that are associated with the first speech, and generate prompt information including the associated speech and the associated text; and

invoke a speech vectorization model to process the associated speech in the prompt information to obtain the associated speech feature vector of the associated speech, and invoke a text feature vector extraction algorithm to process the associated text in the prompt information to obtain the associated text feature vector of the associated text.

In an embodiment of the present disclosure, the recognition unit 403 is further configured to:

input the speech feature vector, the associated speech feature vector, and the associated text feature vector into a speech recognition model, and recognize, by the speech recognition model, the speech feature vector according to the associated speech feature vector and the associated text feature vector to obtain the recognition text of the first speech.

In an embodiment of the present disclosure, there is at least one piece of associated speech, and there is at least one piece of associated text; and the obtaining unit 402 is further configured to:

write each piece of associated speech and each piece of associated text into a preset prompt information template in sequence according to a generation time sequence, to obtain the prompt information.

In an embodiment of the present disclosure, the recognition unit 403 is further configured to:

concatenate the associated speech feature vector corresponding to each piece of associated speech and the associated text feature vector corresponding to each piece of associated text in the order in the prompt information, and input a concatenated vector obtained through concatenating into the speech recognition model; and

recognize, by the speech recognition model, the speech feature vector according to each associated speech feature vector and each associated text feature vector parsed from the concatenated vector, to obtain the recognition text.

In an embodiment of the present disclosure, the device 40 further includes a model training unit (not shown in the figure), and the model training unit is configured to:

construct a plurality of pieces of sample prompt information, where each piece of sample prompt information includes a sample associated speech and a sample associated text that are arranged in a chronological order, and a sample first speech and a sample recognition text corresponding to the sample first speech;

for each piece of sample prompt information, input the sample associated speech and the sample first speech in the sample prompt information into the speech vectorization model, and input a feature vector of each sample associated speech, a feature vector of each sample first speech, and a feature vector of each

sample associated text that are output by the speech vectorization model into a natural language processing model; and

adjust parameters of the natural language processing model and the speech vectorization model according to a loss between an output of the natural language processing model and a target output, where the target output is the sample recognition text in the prompt information; and use the fine-tuned natural language processing model as the speech recognition model.

In an embodiment of the present disclosure, the associated speech and the first speech carry noise; and the recognition unit 403 is further configured to:

recognize a noise feature from the associated speech feature vector using a speech recognition model, and recognize a noise feature in the speech feature vector according to the recognized noise feature; and

filter the recognized noise feature by the speech recognition model, and recognize the speech feature vector from which the noise feature is filtered to obtain the recognition text.

In an embodiment of the present disclosure, the noise includes: a speech of another user other than a main speaker.

The device provided in this embodiment may be used to implement the technical solutions of the foregoing method embodiments, and the implementation principles and technical effects thereof are similar, and details are not described herein again in this embodiment.

To implement the foregoing embodiments, an embodiment of the present disclosure further provides an electronic device.

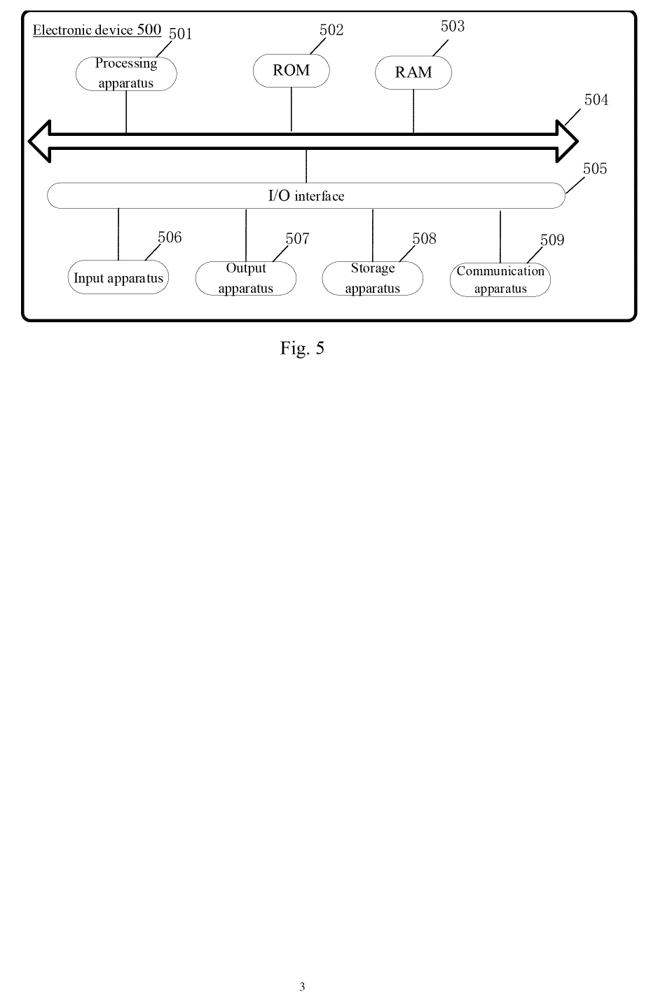

Referring to FIG. 5, FIG. 5 shows a schematic structural diagram of an electronic device 500 suitable for implementing an embodiment of the present disclosure, and the electronic device 500 may be a terminal device or a server. The terminal device may include, but is not limited to, mobile terminals such as a mobile phone, a notebook computer, a digital broadcast receiver, a personal digital assistant (abbreviated as PDA), a tablet computer, a portable media player (abbreviated as PMP), an in-vehicle terminal (such as an in-vehicle navigation terminal), and the like, and fixed terminals such as a digital TV, a desktop computer, and the like. The electronic device shown in FIG. 5 is merely an example, and should not impose any limitation on the function and scope of use of the embodiments of the present disclosure.

As shown in FIG. 5, the electronic device 500 may include a processing apparatus (such as a central processing unit, a graphics processor and the like) 501, which may perform various appropriate actions and processing according to a program stored in a read-only memory (abbreviated as ROM) 502 or a program loaded from a storage apparatus 508 into a random access memory (abbreviated as RAM) 503. In the RAM 503, various programs and data required for operations of the electronic device 500 are also stored. The processing apparatus 501, the ROM 502, and the RAM 503 are connected to each other through a bus 504. An input/output (I/O) interface 505 is also connected to the bus 504.

Usually, the following apparatuses may be connected to the I/O interface 505: an input apparatus 506 including, for example, a touch screen, a touchpad, a keyboard, a mouse, a camera, a microphone, an accelerometer, a gyroscope and the like; an output apparatus 507 including, for example, a liquid crystal display (liquid crystal display, LCD for short), a speaker, a vibrator and the like; the storage apparatus 508 including, for example, a magnetic tape, a hard disk and the like; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all the apparatuses shown. Alternatively, more or fewer apparatuses may be implemented or provided.

In particular, according to the embodiments of the present disclosure, the process described above with reference to the flowchart may be implemented as a computer software program. For example, an embodiment of the present disclosure includes a computer program product, which includes a computer program carried on a computer-readable medium, and the computer program contains program codes for performing the method shown in the flowchart. In such an embodiment, the computer program may be downloaded from a network and installed through the communication apparatus 509, or installed from the storage apparatus 508, or installed from the ROM 502. When the computer program is executed by the processing apparatus 501, the foregoing functions defined in the method of the embodiment of the present disclosure are executed.

It should be noted that the foregoing computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, device, or any combination thereof. More specific examples of the computer-readable storage medium may include, but are not limited to: an electrically connected portable computer magnetic disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or used in combination with an instruction execution system, apparatus, or device. In the present disclosure, the computer-readable signal medium may include a data signal propagated on a baseband or as a part of a carrier, and computer-readable program codes are carried in the data signal. The data signal propagated in this manner may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program codes contained on

the computer-readable medium may be transmitted in any suitable medium, including, but not limited to: a wire, an optical cable, a radio frequency (RF), or any suitable combination thereof.

The computer-readable medium may be contained in the electronic device, or may exist alone without being assembled into the electronic device.

The computer-readable medium carries one or more programs, and when the one or more programs are executed by the electronic device, the electronic device is caused to perform the method shown in the foregoing embodiments.

The computer program codes for performing the operations in the present disclosure may be written in one or more programming languages or a combination thereof, where the programming languages include an object-oriented programming language such as Java, Smalltalk, and C++, and further include conventional procedural programming languages such as "C" language or similar programming languages. The program codes may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or hardware. The name of the unit does not constitute a limitation on the unit itself under certain circumstances. For example, the first obtaining unit may also be described as "a unit for obtaining at least two internet protocol addresses".

The functions described above herein may be at least partially performed by one or more hardware logic components. For example, without limitation, exemplary types of the hardware logic components that

may be used include: a field programmable gate array (FPGA), an application specific integrated circuit (ASIC), an application specific standard product (ASSP), a system on chip (SOC), a complex programmable logical device (CPLD) and the like.

In a first aspect, according to one or more embodiments of the present disclosure, a speech recognition method is provided, including:

determining a speech feature vector of a first speech;

obtaining an associated speech and an associated text that are associated with the first speech, and determining a feature vector of the associated speech and a feature vector of the associated text, respectively, to obtain an associated speech feature vector and an associated text feature vector; and

recognizing the speech feature vector based on the associated speech feature vector and the associated text feature vector, to obtain a recognition text of the first speech.

According to one or more embodiments of the present disclosure, the obtaining an associated speech and an associated text that are associated with the first speech, and determining a feature vector of the associated speech and a feature vector of the associated text, respectively, to obtain an associated speech feature vector and an associated text feature vector includes:

obtaining the associated speech and the associated text that are associated with the first speech, and generating prompt information including the associated speech and the associated text; and

invoking a speech vectorization model to process the associated speech in the prompt information to obtain the associated speech feature vector of the associated speech, and invoking a text feature vector extraction algorithm to process the associated text in the prompt information to obtain the associated text feature vector of the associated text.

According to one or more embodiments of the present disclosure, the recognizing the speech feature vector based on the associated speech feature vector and the associated text feature vector, to obtain a recognition text of the first speech includes:

inputting the speech feature vector, the associated speech feature vector, and the associated text feature vector into a speech recognition model, and recognizing, by the speech recognition model, the speech feature vector according to the associated speech feature vector and the associated text feature vector to obtain the recognition text of the first speech.

According to one or more embodiments of the present disclosure, there is at least one piece of associated speech, and there is at least one piece of associated text; and

the generating prompt information including the associated speech and the associated text includes:

writing each piece of associated speech and each piece of associated text into a preset prompt information template in sequence according to a generation time sequence, to obtain the prompt information.

According to one or more embodiments of the present disclosure, the inputting the speech feature vector, the associated speech feature vector, and the associated text feature vector into a speech recognition

model, and recognizing, by the speech recognition model, the speech feature vector according to the associated speech feature vector and the associated text feature vector includes:

concatenating the associated speech feature vector corresponding to each piece of associated speech and the associated text feature vector corresponding to each piece of associated text in an order in the prompt information, and inputting a concatenated vector obtained through concatenating into the speech recognition model; and

recognizing, by the speech recognition model, the speech feature vector according to each associated speech feature vector and each associated text feature vector parsed from the concatenated vector, to obtain the recognition text.

According to one or more embodiments of the present disclosure, the method further includes performing fine-tuning on a pre-trained natural language processing model and the speech vectorization model based on the following steps, to obtain the speech recognition model and the speech vectorization model:

constructing a plurality of pieces of sample prompt information, where each piece of sample prompt information includes a sample associated speech and a sample associated text that are arranged in a chronological order, and a sample first speech and a sample recognition text corresponding to the sample first speech;

for each piece of sample prompt information, inputting the sample associated speech and the sample first speech in the sample prompt information into the speech vectorization model, and inputting a feature vector of each sample associated speech, a feature vector of each sample first speech, and a feature vector of the sample associated text that are output by the speech vectorization model into the natural language processing model; and

adjusting parameters of the natural language processing model and the speech vectorization model according to a loss between an output of the natural language processing model and a target output, where the target output is the sample recognition text in the prompt information; and using the fine-tuned natural language processing model as the speech recognition model.

According to one or more embodiments of the present disclosure, the associated speech and the first speech carry noise; and the inputting the speech feature vector, the associated speech feature vector, and the associated text feature vector into a speech recognition model, and recognizing, by the speech recognition model, the speech feature vector according to the associated speech feature vector and the associated text feature vector to obtain the recognition text of the first speech includes:

recognizing a noise feature from the associated speech feature vector using the speech recognition model, and recognizing a noise feature in the speech feature vector according to the recognized noise feature; and

filtering, by the speech recognition model, the recognized noise feature, and recognizing the speech feature vector from which the noise feature is filtered to obtain the recognition text.

According to one or more embodiments of the present disclosure, the noise includes: a speech of another user other than a main speaker.

In a second aspect, according to one or more embodiments of the present disclosure, a speech recognition device is provided, including:

a determination unit, configured to determine a speech feature vector of a first speech;

an obtaining unit, configured to obtain an associated speech and an associated text that are associated with the first speech, and determine a feature vector of the associated speech and a feature vector of the associated text, respectively, to obtain an associated speech feature vector and an associated text feature vector; and

a recognition unit, configured to recognize the speech feature vector based on the associated speech feature vector and the associated text feature vector, to obtain a recognition text of the first speech.

According to one or more embodiments of the present disclosure, the obtaining unit is further configured to:

obtain the associated speech and the associated text that are associated with the first speech, and generate prompt information including the associated speech and the associated text; and

invoke a speech vectorization model to process the associated speech in the prompt information to obtain the associated speech feature vector of the associated speech, and invoke a text feature vector extraction algorithm to process the associated text in the prompt information to obtain the associated text feature vector of the associated text.

According to one or more embodiments of the present disclosure, the recognition unit is further configured to:

input the speech feature vector, the associated speech feature vector, and the associated text feature vector into a speech recognition model, and recognize, by the speech recognition model, the speech feature vector according to the associated speech feature vector and the associated text feature vector to obtain the recognition text of the first speech.

According to one or more embodiments of the present disclosure, there is at least one piece of associated speech, and there is at least one piece of associated text; and the obtaining unit is further configured to:

write each piece of associated speech and each piece of associated text into a preset prompt information template in sequence according to a generation time sequence, to obtain the prompt information.

According to one or more embodiments of the present disclosure, the recognition unit is further configured to:

concatenate the associated speech feature vector corresponding to each piece of associated speech and the associated text feature vector corresponding to each piece of associated text in an order in the prompt information, and input a concatenated vector obtained through concatenating into the speech recognition model; and

recognize, by the speech recognition model, the speech feature vector according to each associated speech feature vector and each associated text feature vector parsed from the concatenated vector, to obtain the recognition text.

According to one or more embodiments of the present disclosure, the device further includes a model training unit, and the model training unit is configured to:

construct a plurality of pieces of sample prompt information, where each piece of sample prompt information includes a sample associated speech and a sample associated text that are arranged in a chronological order, and a sample first speech and a sample recognition text corresponding to the sample first speech;

for each piece of sample prompt information, input the sample associated speech and the sample first speech in the sample prompt information into the speech vectorization model, and input a feature vector of each sample associated speech, a feature vector of each sample first speech, and a feature vector of each sample associated text that are output by the speech vectorization model into a natural language processing model; and

adjust parameters of the natural language processing model and the speech vectorization model according to a loss between an output of the natural language processing model and a target output, where the target output is the sample recognition text in the prompt information; and use the fine-tuned natural language processing model as the speech recognition model.

According to one or more embodiments of the present disclosure, the associated speech and the first speech carry noise; and the recognition unit is further configured to:

recognize a noise feature from the associated speech feature vector using the speech recognition model, and recognize a noise feature in the speech feature vector according to the recognized noise feature; and

filter, by the speech recognition model, the recognized noise feature, and recognize the speech feature vector from which the noise feature is filtered to obtain the recognition text.

According to one or more embodiments of the present disclosure, the noise includes: a speech of another user other than a main speaker.

In a third aspect, according to one or more embodiments of the present disclosure, an electronic device is provided, including: at least one processor and a memory;

the memory stores a computer-executed instruction; and

the at least one processor executes the computer-executed instruction stored in the memory, to cause the at least one processor to execute the speech recognition method according to the first aspect above and various possible designs of the first aspect.

In a fourth aspect, according to one or more embodiments of the present disclosure, a computer-readable storage medium is provided, where a computer-executed instruction is stored in the computer-readable storage medium, and when the computer-executed instruction is executed by a processor, the

speech recognition method according to the first aspect above and various possible designs of the first aspect is implemented.

In a fifth aspect, according to one or more embodiments of the present disclosure, a computer program product is provided, including a computer program, and when the computer program is executed by a processor, the speech recognition method according to the first aspect above and various possible designs of the first aspect is implemented.

The foregoing description is merely illustration of preferred embodiments of the present disclosure and applied technical principles. A person skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, the foregoing features and the technical features having similar functions disclosed in the present disclosure (but not limited thereto) may be replaced each other to form a technical solution.

In addition, although the operations are depicted in a specific order, this should not be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features described in the context of separate embodiments may alternatively be implemented in combination in a single embodiment. In contrast, various features described in the context of a single embodiment may alternatively be implemented in multiple embodiments individually or in any suitable sub combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms for implementing the claims.

1. A speech recognition method, comprising:
determining a speech feature vector of a first speech;
obtaining an associated speech and an associated text that are associated with the first speech, and determining a feature vector of the associated speech and a feature vector of the associated text, respectively, to obtain an associated speech feature vector and an associated text feature vector; and
recognizing the speech feature vector based on the associated speech feature vector and the associated text feature vector, to obtain a recognition text of the first speech.

2. The method of claim 1, wherein the obtaining an associated speech and an associated text that are associated with the first speech, and determining a feature vector of the associated speech and a feature vector of the associated text, respectively, to obtain an associated speech feature vector and an associated text feature vector comprises:
obtaining the associated speech and the associated text that are associated with the first speech, and generating prompt information comprising the associated speech and the associated text; and
invoking a speech vectorization model to process the associated speech in the prompt information to obtain the associated speech feature vector of the associated speech, and invoking a text feature vector extraction algorithm to process the associated text in the prompt information to obtain the associated text feature vector of the associated text.

3. The method of claim 2, wherein the recognizing the speech feature vector based on the associated speech feature vector and the associated text feature vector, to obtain a recognition text of the first speech comprises:
inputting the speech feature vector, the associated speech feature vector, and the associated text feature vector into a speech recognition model, and recognizing, by the speech recognition model, the speech feature vector according to the associated speech feature vector and the associated text feature vector to obtain the recognition text of the first speech.

4. The method of claim 3, wherein there is at least one piece of associated speech, and there is at least one piece of associated text; and
the generating prompt information comprising the associated speech and the associated text comprises:
writing each piece of associated speech and each piece of associated text into a preset prompt information template in sequence according to a generation time sequence, to obtain the prompt information.

5. The method of claim 4, wherein the inputting the speech feature vector, the associated speech feature vector, and the associated text feature vector into a speech recognition model, and recognizing, by the speech recognition model, the speech feature vector according to the associated speech feature vector and the associated text feature vector comprises:
concatenating an associated speech feature vector corresponding to each piece of associated speech and an associated text feature vector corresponding to each piece of associated text in an order in the prompt information, and inputting a concatenated vector obtained through concatenating into the speech recognition model; and
recognizing, by the speech recognition model, the speech feature vector according to each associated speech feature vector and each associated text feature vector parsed from the concatenated vector, to obtain the recognition text.

6. The method of claim 3, wherein the method further comprises: performing fine-tuning on a pre-trained natural language processing model and the speech vectorization model based on following steps, to obtain the speech recognition model and the speech vectorization model:
constructing a plurality of pieces of sample prompt information, wherein each piece of sample prompt information comprises a sample associated speech and a sample associated text that are arranged in a chronological order, and a sample first speech and a sample recognition text corresponding to the sample first speech;
for each piece of sample prompt information, inputting the sample associated speech and the sample first speech in the sample prompt information into the speech vectorization model, and inputting a feature vector of each sample associated speech, a feature vector of each sample first speech, and a feature vector of each sample associated text that are output by the speech vectorization model into the natural language processing model;
adjusting parameters of the natural language processing model and the speech vectorization model according to a loss between an output of the natural language processing model and a target output, wherein the target output is the sample recognition text in the prompt information; and
using the fine-tuned natural language processing model as the speech recognition model.

7. The method of claim 3, wherein the associated speech and the first speech carry noise; and the inputting the speech feature vector, the associated speech feature vector, and the associated text feature vector into a speech recognition model, and recognizing, by the speech recognition model, the speech feature vector according to the associated speech feature vector and the associated text feature vector to obtain the recognition text of the first speech comprises:
recognizing, using the speech recognition model, a noise feature from the associated speech feature vector, and recognizing a noise feature in the speech feature vector according to the recognized noise feature; and
filtering, by the speech recognition model, the recognized noise feature, and recognizing the speech feature vector from which the noise feature is filtered to obtain the recognition text.

8. The method of claim 7, wherein the noise comprises: a speech of another user other than a main speaker.

9. An electronic device, comprising: a processor and a memory;
wherein the memory stores a computer-executed instruction; and
the processor executes the computer-executed instruction stored in the memory, to cause the processor to:
determine a speech feature vector of a first speech;
obtain an associated speech and an associated text that are associated with the first speech, and determine a feature vector of the associated speech and a feature vector of the associated text, respectively, to obtain an associated speech feature vector and an associated text feature vector; and
recognize the speech feature vector based on the associated speech feature vector and the associated text feature vector, to obtain a recognition text of the first speech.

10. The electronic device of claim 9, wherein the processor is further caused to:
obtain the associated speech and the associated text that are associated with the first speech, and generating prompt information comprising the associated speech and the associated text; and
invoke a speech vectorization model to process the associated speech in the prompt information to obtain the associated speech feature vector of the associated speech, and invoke a text feature vector extraction algorithm to process the associated text in the prompt information to obtain the associated text feature vector of the associated text.

11. The electronic device of claim 10, wherein the processor is further caused to:
input the speech feature vector, the associated speech feature vector, and the associated text feature vector into a speech recognition model, and recognizing, by the speech recognition model, the speech feature vector according to the associated speech feature vector and the associated text feature vector to obtain the recognition text of the first speech.

12. The electronic device of claim 11, wherein there is at least one piece of associated speech, and there is at least one piece of associated text; and
the processor is further caused to:
write each piece of associated speech and each piece of associated text into a preset prompt information template in sequence according to a generation time sequence, to obtain the prompt information.

13. The electronic device of claim 12, wherein the processor is further caused to:
concatenate an associated speech feature vector corresponding to each piece of associated speech and an associated text feature vector corresponding to each piece of associated text in an order in the prompt information, and input a concatenated vector obtained through concatenating into the speech recognition model; and
recognize, by the speech recognition model, the speech feature vector according to each associated speech feature vector and each associated text feature vector parsed from the concatenated vector, to obtain the recognition text.

14. The electronic device of claim 11, wherein the processor is further caused to: perform fine-tuning on a pre-trained natural language processing model and the speech vectorization model based on following steps, to obtain the speech recognition model and the speech vectorization model:
constructing a plurality of pieces of sample prompt information, wherein each piece of sample prompt information comprises a sample associated speech and a sample associated text that are arranged in a chronological order, and a sample first speech and a sample recognition text corresponding to the sample first speech;
for each piece of sample prompt information, inputting the sample associated speech and the sample first speech in the sample prompt information into the speech vectorization model, and inputting a feature vector of each sample associated speech, a feature vector of each sample first speech, and a feature vector of each sample associated text that are output by the speech vectorization model into the natural language processing model;
adjusting parameters of the natural language processing model and the speech vectorization model according to a loss between an output of the natural language processing model and a target output, wherein the target output is the sample recognition text in the prompt information; and
using the fine-tuned natural language processing model as the speech recognition model.

15. The electronic device of claim 11, wherein the associated speech and the first speech carry noise; and the processor is further caused to:
recognize, using the speech recognition model, a noise feature from the associated speech feature vector, and recognizing a noise feature in the speech feature vector according to the recognized noise feature; and
filter, by the speech recognition model, the recognized noise feature, and recognizing the speech feature vector from which the noise feature is filtered to obtain the recognition text.

16. The electronic device of claim 15, wherein the noise comprises: a speech of another user other than a main speaker.

17. A non-transitory computer-readable storage medium, wherein a computer-executed instruction is stored in the computer-readable storage medium, and when the computer-executed instruction is executed by a processor, the processor is caused to:
determine a speech feature vector of a first speech;
obtain an associated speech and an associated text that are associated with the first speech, and determine a feature vector of the associated speech and a feature vector of the associated text, respectively, to obtain an associated speech feature vector and an associated text feature vector; and
recognize the speech feature vector based on the associated speech feature vector and the associated text feature vector, to obtain a recognition text of the first speech.

18. The storage medium of claim 17, wherein the processor is further caused to:
obtain the associated speech and the associated text that are associated with the first speech, and generating prompt information comprising the associated speech and the associated text; and
invoke a speech vectorization model to process the associated speech in the prompt information to obtain the associated speech feature vector of the associated speech, and invoke a text feature vector extraction algorithm to process the associated text in the prompt information to obtain the associated text feature vector of the associated text.

19. The storage medium of claim 18, wherein the processor is further caused to:
input the speech feature vector, the associated speech feature vector, and the associated text feature vector into a speech recognition model, and recognizing, by the speech recognition model, the speech feature vector according to the associated speech feature vector and the associated text feature vector to obtain the recognition text of the first speech.

20. The storage medium of claim 19, wherein there is at least one piece of associated speech, and there is at least one piece of associated text; and
the processor is further caused to:
write each piece of associated speech and each piece of associated text into a preset prompt information template in sequence according to a generation time sequence, to obtain the prompt information.
